(19) United States
(12) Patent Application Publication
(10) Pub. No.: US 2009/0090286 A1
(43) Pub. Date: Apr. 9, 2009

(54) Armed Remotely Operated Vehicle

(76) Inventors: Kryill V. Korolenko, Portsmouth, RI (US); Robert Douglas Christ, Abita Springs, LA (US)

Correspondence Address: NAVAL UNDERSEA WARFARE CENTER;DIVISION NEWPORT, 1176 HOWELL STREET, CODE 000C, NEWPORT, RI, 02841, US

(21) Appl. No.: 11/869,111

(22) Filed: Oct. 9, 2007

(51) Int. Cl. B63G 8/28; H04B 14/00

(52) U.S. Cl. 114/5; 114/316; 340/851

(57) ABSTRACT

A remotely operated vehicle system includes a vehicle having a propulsor and a steering means. A remote operating console is provided that is capable of providing power, receiving sensor signals and controlling the vehicle. The vehicle is connected to the console by a tether. The tether having elements supporting power, sensor and control transmission. The vehicle has video sensors and sonar sensors. An underwater gun is positioned on the vehicle and joined to the console to fire in response to control signals. In further embodiments the vehicle can be provided with a turret for aiming the gun and the video sensor.

### STATEMENT OF GOVERNMENT INTEREST

The invention described herein may be manufactured and used by or for the Government of the United States of America for Governmental purposes without the payment of any royalties thereon or therefore.

### CROSS REFERENCE TO OTHER PATENTS

None.

### BACKGROUND OF THE INVENTION

(1) Field of the Invention

The present invention relates generally to a remotely operated underwater vehicle having an underwater gun.

(2) Description of the Prior Art

The Navy has several underwater missions that can best be accomplished through use of an unmanned underwater vehicle. These include swimmer detection and mine neutralization. In both of these areas, positive identification of the target is important.

Previous inventions in this field have not focused on the need for positive identification of the target. As such, they rely on autonomous operation of the vehicle and do not transmit information to a control platform. Prior art devices make no provision for a video camera on the device that allows a remote operator to view a target before activating the underwater gun.

### SUMMARY OF THE INVENTION

Accordingly, there is provided a remotely operated vehicle system that includes a vehicle having a propulsor and a steering means. A remote operating console is provided that is capable of providing power, receiving sensor signals and controlling the vehicle. The vehicle is connected to the console by a tether. The tether having elements supporting power, sensor and control transmission. The vehicle has video sensors and sonar sensors. An underwater gun is positioned on the vehicle and joined to the console to fire in response to control signals. In further embodiments the vehicle can be provided with a turret for aiming the gun and a video sensor.

### BRIEF DESCRIPTION OF THE DRAWINGS

The foregoing invention will become readily apparent by referring to the following detailed description and the appended drawings in which:

FIG. 1 is a diagram showing a remotely operated vehicle of the current invention deployed from a vessel; and

FIG. 2 is a diagram of an alternate embodiment of a remotely operated vehicle of the current invention.

### DESCRIPTION OF THE INVENTION

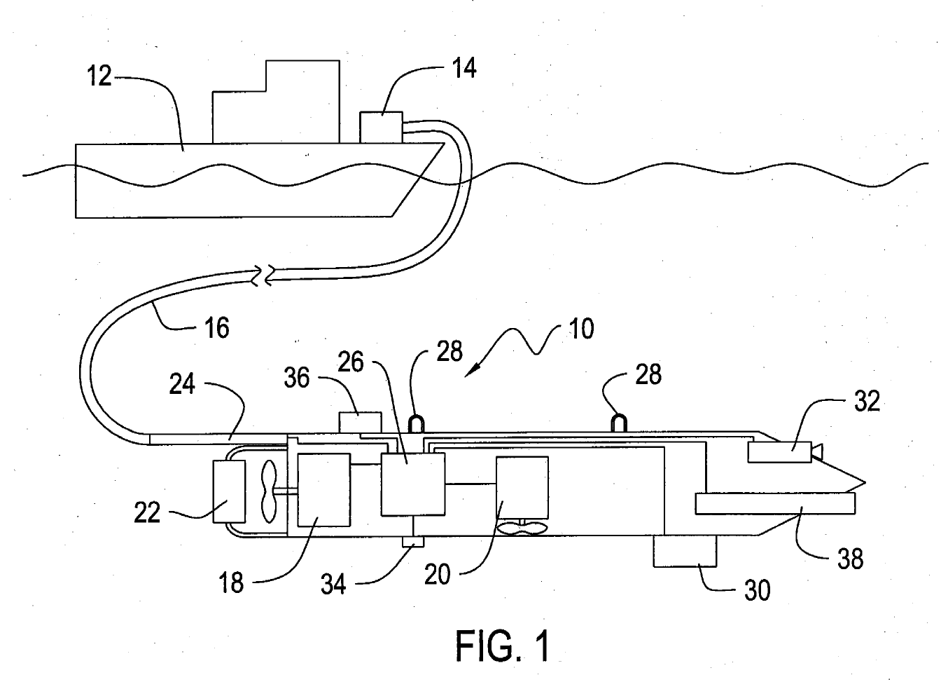

In FIG. 1, there is shown a remotely operated vehicle 10. Vehicle 10 can be deployed from another vessel 12 or another remote site such as a fixed platform or a shore location. The remote site 12 has a console 14 for viewing data and controlling vehicle 10. Console 14 can also include a generator or other power source for the vehicle 10. A tether 16 joins vehicle 10 to console 14. Tether 16 has power cables incorporated therein. Tether 16 also includes cables for transmitting control signals to vehicle 10 and signal cables for transmitting sensor signals from vehicle 10 back to console 14. Tether can be an all electrical cable or a fiber optic cable having a power cable. Vehicle 10 can be deployed over the side or it can be configured as a torpedo or unmanned underwater vehicle allowing deployment from a conventional launch tube.

Vehicle 10 has a propulsor 18 and a vertical thruster 20 for maneuvering. Propulsor 18 can be directed by a rudder 22, by otherwise directing the thrust of the propulsor 18 or by provision of a multiengine propulsor having offset thrust. Vehicle 10 is joined to tether 16 by a tether guide tube 24. Tether guide tube 24 keeps tether 16 from becoming entangled in propulsor 18. Tether 16 is joined in communication with a controller 26 for distributing power and control signals to the other components of vehicle 10. Controller 26 also includes telemetry circuitry for relaying sensor signals back through tether 16 to console 14. Vehicle 10 has lift points 28 for easing deployment and capture of the vehicle.

Vehicle 10 has instruments for locating underwater objects and allowing navigation. Sonar 30 is provided for acoustically locating objects of interest. Sonar 30 can have active and passive components. As part of the active components, sonar 30 can incorporate a speaker or transducer that will enable audio communication underwater. A forward looking video camera 32 is provided so that objects of interest can be observed and identified. Vehicle 10 can also include a Doppler velocity locator 34 and an undersea beacon locator system 36. Doppler velocity locator 34 provides an indication of vehicle 10 velocity to ensure accurate navigation. Undersea beacon locator system 36 uses acoustic signals to provide undersea coordinate location similar to a global positioning system.

An underwater gun 38 is provided on the front of vehicle 10. Gun 38 is joined to controller 26 allowing it to be discharged on a signal from console 14. Gun 38 can be an underwater gun using the same technology as that used in the Russian APS underwater assault rifle, ASM-DT underwater assault rifle, SPP-1 pistol or Heckler & Koch P11. These technologies have a range of up to 30 m. Other special purpose technologies are available for this gun. Multiple guns 38 with the same aim point can be positioned on vehicle 10 spaced apart from one another. This will allow a higher rate of fire because the wake and turbulence from a previously fired projectile won't interfere with the currently firing projectile.

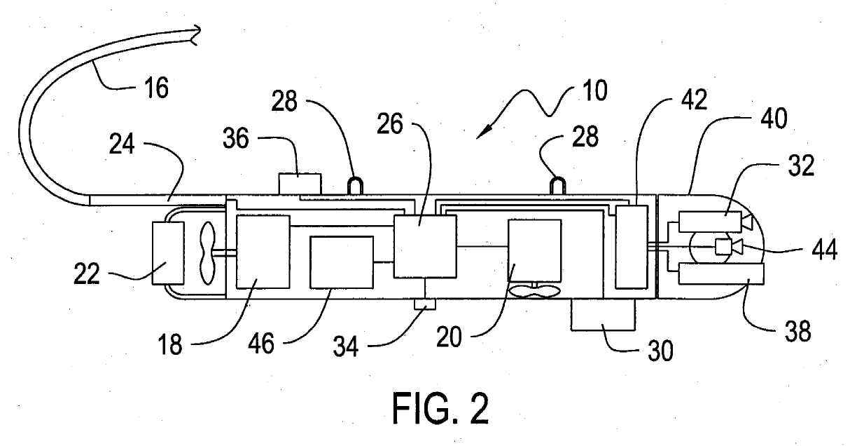

FIG. 2 shows an alternate embodiment having a turret 40 and actuator 42. Turret 40 allows rotation and tilt of devices mounted thereon to improve aiming. Video camera 32 and gun 38 are mounted on to allow aiming of these devices to a region in front of vehicle 10. A light 44 is further provided on turret 40 for illumination of dim underwater areas. This embodiment also features a battery 46 on-board vehicle 10. This will allow a thinner, lighter tether 16.

It is to be understood that the foregoing description and specific embodiments are merely illustrative of the best mode of the invention and the principles thereof, and that various modifications and additions may be made to the invention by those skilled in the art, without departing from the spirit and scope of this invention, which is therefore understood to be limited only by the scope of the appended claims.

1. A remotely operated vehicle system comprising:
a vehicle having a propulsor and a steering means;
a remote operating console having power providing means, sensor receiving means, and control means;
a tether joined between said vehicle and said remote operating console having power elements, control elements and sensor elements, the power elements providing power to the vehicle, the control elements providing control of said propulsor and steering means to said vehicle, and the sensor elements providing sensor information to said remote operating platform;
a video sensor capable of underwater viewing and target identification positioned on said vehicle and joined to provide video signals to said tether sensor elements;
an acoustic sensor positioned on said vehicle and joined to provide acoustic signals to said tether sensor elements; and
an underwater gun positioned on said vehicle and joined to fire in response to control signals from said tether control elements.

2. The device of claim 1 further comprising an illumination means capable of providing sufficient illumination for distinguishing underwater objects positioned on said vehicle and joined to said tether power elements and control elements.

3. The device of claim 1 further comprising an underwater speaker positioned on said vehicle and joined to said tether control elements.

4. The device of claim 1 wherein said tether uses optical fiber for said control elements and said sensor elements.

5. The device of claim 1 further comprising a turret joined to said vehicle, said gun being mounted on said turret and said turret being joined to said tether control elements for positioning said gun.

6. The device of claim 5 wherein said video sensor is positioned on said turret and positionable by said turret.

7. The device of claim 1 wherein said gun comprises multiple guns positioned apart from one another on said vehicle.

8. A remotely operated vehicle system comprising:
a vehicle having a propulsor and a steering means;
a battery provided on said vehicle for powering the vehicle;
a remote operating console having sensor receiving means, and control means;
a tether joined between said vehicle and said remote operating console having control elements and sensor elements, the control elements providing control of said propulsor and steering means to said vehicle, and the sensor elements providing sensor information to said remote operating platform;
a video sensor capable of underwater viewing positioned on said vehicle and joined to provide video signals to said tether sensor elements, said remote operating console being capable of receiving video signals;
an acoustic sensor positioned on said vehicle and joined to provide acoustic signals to said tether sensor elements; and
an underwater gun positioned on said vehicle and joined to fire in response to control signals from said tether control elements provided by said remote operating console.

9. The device of claim 8 further comprising an illumination means capable of providing sufficient illumination for distinguishing underwater objects positioned on said vehicle and joined to said control elements and receiving power from said battery.

10. The device of claim 8 further comprising an underwater speaker positioned on said vehicle and joined to said tether control elements.

11. The device of claim 8 wherein said tether uses optical fiber for said control elements and said sensor elements.

12. The device of claim 8 further comprising a turret joined to said vehicle, said gun being mounted on said turret and said turret being joined to said tether control elements for positioning said gun.

13. The device of claim 12 wherein said video sensor is positioned on said turret and positionable by said turret.

14. The device of claim 8 wherein said gun comprises multiple guns positioned apart from one another on said vehicle.

15. The device of claim 1 wherein said acoustic sensor comprises an undersea beacon locator system.

16. The device of claim 1 wherein said vehicle propulsor includes a vertical thruster.

17. A method for neutralizing underwater targets comprising:
providing an undersea vehicle having an underwater gun positioned thereon;
tethering an undersea vehicle to a console on a vessel;
deploying said undersea vehicle from the vessel;
communicating with said undersea vehicle via said console;
maneuvering said undersea vehicle to a vicinity of the target;
transmitting video images from said undersea vehicle to said console;
identifying the target at said console; and
firing said underwater gun toward the identified target.

18. The method of claim 17 further comprising positioning said undersea vehicle geographically by receiving an acoustic signal at said undersea vehicle.

19. The method of claim 17 further comprising aiming said underwater gun toward the target.

20. The method of claim 19 further comprising repositioning said underwater gun with respect to said underwater vehicle.
